(19) United States
(12) Patent Application Publication
(10) Pub. No.: US 2026/0264386 A1
(43) Pub. Date: Sep. 10, 2026

(54) METHOD AND APPARATUS FOR TRANSFERRING A BLANK CUT ONTO A COUNTER ELEMENT

(71) Applicant: OPTIMA life science GmbH, Schwäbisch Hall (DE)

(72) Inventor: Philipp Winterer, Schwäbisch Hall (DE)

(73) Assignee: OPTIMA life science GmbH, Schwäbisch Hall (DE)

(21) Appl. No.: 19/167,717

(22) PCT Filed: Feb. 22, 2024
(86) PCT No.: PCT/EP2024/054476

§ 371 Date: Sep. 22, 2025

(30) Foreign Application Priority Data
Mar. 22, 2023 (DE) 102023107211.0

(51) Int. Cl. B32B 37/00; B32B 38/18; H01M 8/1004

(52) U.S. Cl. CPC B32B 37/0053; B32B 38/1858; B32B 2457/10; H01M 8/1004

(57) ABSTRACT

The invention relates to a method and an apparatus for transferring a blank (2) onto a web-type counter-element, wherein the blank (2) is held on a planar holding surface (100) of a gripping device (10) and positioned by way of the gripping device (10) relative to the web-type counter-element in a delivery position, the web-type counter-element is advanced to the holding surface (100) by way of an application device, the application device is moved along the holding surface (100), such that the web-type counter-element is laminated onto the blank (2) by way of the application device moving along the holding surface (100), and the gripping device (10) releases the blank (2) after lamination of the counter-element onto the blank (2).

### TECHNICAL FIELD AND PRIOR ART

The invention relates to a method and apparatus for transferring a blank onto a counter-element.

It is known to produce multilayer products, also known as laminates or stacks, by using web-type processing, wherein materials for layers of the product are each provided as a material web. The material webs are then conventionally joined together between two rollers.

Stacks or laminates are known for a very wide range of applications, for example for wound dressings, hygiene products, textile products, among others.

For fuel cells, redox flow batteries and other applications, stacks or laminates are known which comprise a generally very sensitive membrane. For example, “membrane electrode assemblies” (MEA for short) are known for fuel cells which comprise a “catalyst coated membrane” (CCM for short) together with two electrodes configured as cathode and anode and between which the membrane is arranged. In such cases, it is known to mount the CCM on a frame or between two frames, which can also be designated seals or partial frame seals. The CCM plus the frame or frames can be further processed as a blank.

To connect a membrane to a frame, DE 102020214263 A1 discloses an apparatus and method for applying a membrane blank to a moving first material web, in particular for transferring a catalyst-coated membrane for a membrane electrode assembly onto a first material web consisting of a frame material, wherein membrane blanks are supplied by way of a second material web which is delaminated onto the moving first material web prior to or during application of a membrane blank.

With thin blanks in particular and/or with blanks for frames with window cut-outs introduced into the blanks, however, delamination of the blank from a blank-supplying carrier web is associated with technical difficulties.

### OBJECT AND SOLUTION

The object of the invention is to provide a method and an apparatus for reliably transferring a blank onto a counter-element without entrapping air.

This object is achieved by the method and the apparatus having the features of claims 1 and 8. Advantageous embodiments result from the dependent claims.

According to a first aspect, a method is provided for transferring a blank onto a web-type counter-element, wherein the blank is held on a planar holding surface of a gripping device and positioned by way of the gripping device relative to the web-type counter-element in a delivery position, the web-type counter-element is advanced to the holding surface by way of an application device, the application device is moved along the holding surface, such that the web-type counter-element is laminated onto the blank by way of the application device moving along the holding surface, and the gripping device releases the blank after lamination of the counter-element onto the blank.

In an embodiment, the web-type counter-element is a carrier web, on which the blank is deposited for further processing. In another embodiment, the counter-element is a carrier web on which a further blank has already been deposited, such that a stack is built up wholly or partly through transfer of the blank onto the web-type counter-element. In still other embodiments, the counter-element is a material web which forms a layer of a stack to be built up. The web-type counter-element is not restricted to the stated examples, however.

In the context of the application, “lamination” denotes any method for permanently or temporarily joining two layers, in particular for adhesion and bonding of layers. In an embodiment, the counter-element and/or the blank have/has an adhesive layer for laminating the counter-element to the blank. In other embodiments, joining takes place by way of contact pressure during movement of the application device along the holding surface. In still another embodiment, the counter-element with the blank is supplied, after transfer of the blank onto the counter-element, to a fixing device, for example a thermal fixing device.

In an embodiment, the application device is a doctor blade which is displaced along the holding surface. The material and/or shape of a doctor blade pressing the web-type counter-element against the blank can be selected by a person skilled in the art to suit the use case, in order to ensure bubble-free transfer.

In another embodiment, the application device is an application roller which is rolled along the holding surface. The material of a circumferential surface of the application roller can here be selected by a person skilled in the art to suit the use case. In an embodiment, the application roller is a bristle roller. In other embodiments, the application roller has a smooth surface, wherein, depending on the use case, the surface is made from a rigid material or is flexible.

In an embodiment, the holding surface is larger than the blank at least in the direction of movement of the application device during lamination, wherein the counter-element is secured on the holding surface upstream of the blank by way of a securing element advanced to the holding surface. The counter-element may in this case be reliably secured on the holding surface without this securing hindering lamination of the counter-element onto the blank and/or the blank being damaged by being secured. The securing element further ensures that the counter-element remains pressed against the blank during movement of the application device.

In an embodiment, the application device is advanced to the holding surface downstream of the securing element and upstream of the blank. In this way, reliable lamination is ensured even at an edge of the blank facing the securing element.

In an embodiment, before the application device is advanced, and before the securing element, if present, is advanced, the web-type counter-element is brought to a standstill in a starting position for transfer of the blank, wherein in particular the counter-element is clamped by a clamping device upstream of the delivery position of the blank in the direction of movement of the application device during lamination. By bringing the counter-element to a standstill in a defined starting position, it is possible to position the gripping device precisely relative to the counter-element. This is in particular advantageous if the counter-element likewise already comprises a blank and the blank picked up by the gripping device is to be positioned with a high level of accuracy on the blank of the counter-element. The counter-element is in this case merely clamped at one clamping region, such that compensatory movement of the counter-element on advance of the application device and, if present, of the securing element is possible to prevent tensions in the web-type counter-element.

In an embodiment, provision is made for the application device to be removed from the holding surface after lamination of the counter-element onto the blank and for the web-type counter-element to be moved into the starting position. In an embodiment, the gripping device releases the blank prior to movement of the application device into the starting position. If present, the securing element may be moved at the same time as the application device or in time offset manner relative thereto to detach the blank at an angle from the gripping device. In other embodiments, the gripping device is moved with the web-type counter-element and the blank remains on the holding surface on movement of the counter-element into the starting position. This prevents the blank from becoming detached from the counter-element on movement of the counter-element into the starting position. In the starting position, the counter-element is preferably arranged in a plane, such that the blank can be reliably delivered to the counter-element on release of the blank by the gripping device.

The blank is positionable in a suitable delivery position relative to the counter-element by way of the gripping device, wherein an axis of the advanced application device is preferably arranged parallel to a plane of the web-type counter-element in the starting position. In some advantageous embodiments, to achieve a simple arrangement and to position the blank in the delivery position, the holding surface is arranged parallel to a plane of the web-type counter-element in the starting position.

In an embodiment, the blank is positioned in the delivery position above the counter-element, wherein the application device is advanced to the holding surface from below. This prevents gravitational forces which might bring about detachment of the blank from the counter-element from acting on the blank after transfer of the blank onto the counter-element and after release of the blank by the gripping device.

According to a second aspect, an apparatus is provided for transferring a blank onto a web-type counter-element which comprises a gripping device with a planar holding surface and an application device, wherein the gripping device is configured such that the blank is holdable on the holding surface and positionable relative to the web-type counter-element in a delivery position by way of the gripping device, and wherein the application device is adjustably mounted and is advanceable to the holding surface and is movable along the holding surface for lamination of the counter-element onto the blank.

In an embodiment, the application device is an application roller which is configured such that the application roller can be rolled along the holding surface. The application roller allows gentle, bubble-free lamination of the counter-element onto the blank. In other embodiments, the application device is a doctor blade which is configured such that the doctor blade is adjustable along the holding surface. In an embodiment, the doctor blade is configured such that the contact area of the doctor blade with the counter-element is minimized during lamination.

In an embodiment, the holding surface is larger than the blank at least in the direction of movement of the application device during lamination, wherein a securing element which can be advanced to the holding surface is provided and is configured to secure the counter-element on the holding surface upstream of the blank. The securing element is configurable by a person skilled in the art to suit the use case, so as to ensure reliable, slippage-free securing of the counter-element on the holding surface.

In an embodiment, the application device, in particular the application roller, can be advanced to the holding surface downstream of the securing element and upstream of the blank. In an embodiment, the application device and the securing element are advanced at the same time. In other embodiments, the application device and the securing element are advanced in time-offset manner.

In an embodiment of the apparatus, provision is made for it to be possible to bring the web-type counter-element to a standstill in a starting position before the application device is advanced for transfer of the blank, wherein the apparatus in particular comprises a clamping device which is configured such that the counter-element is clampable by the clamping device upstream of the delivery position of the blank in the direction of movement of the application device during lamination. The clamping device allows the web-type counter-element to be brought reliably to a standstill in a starting position in a clamping region upstream of a starting position of the application device, wherein the application device is movable out of the starting position and along the holding surface. To ensure tension-free movement of the counter-element on advance of the application device and during lamination, the web-type counter-element is not clamped at an opposing end, such that a portion of the counter-element can, for example, be fed from a web reserve.

In an embodiment, the gripping device is configured to release the blank directly after lamination of the counter-element onto the blank. The application device and, if present, the securing element are movable into the starting position after release of the blank by the gripping device, wherein the securing element is configured to be moved at the same time as the application device or, to detach the blank from the gripping device at an angle, with a time offset relative thereto, depending on use case. In other embodiments, the gripping device is configured to move the blank held on the holding surface with the counter-element into the starting position of the counter-element after lamination of the counter-element onto the blank. Movement of the gripping device is in this case coordinated with movement of the counter-element in such a way that detachment forces between the blank and the counter-element are avoided during movement or at least reduced to a tolerable level.

In an embodiment, the gripping device is configured to position the blank in the delivery position above the counter-element, wherein the application device is configured such that the application device can be advanced to the holding surface from below.

The gripping device is suitably configured to hold the blank in the delivery position against gravitational forces acting thereon. In an embodiment, the gripping device is a vacuum gripping device.

### BRIEF DESCRIPTION OF THE DRAWINGS

Further advantages and aspects of the invention can be found in the claims and in the description of an example of the invention that is explained below on the basis of the schematic figures, in which:

FIG. 1: shows an example of an apparatus for transferring a blank onto a web-type counter-element;

FIG. 2: shows the apparatus according to FIG. 1, prior to transfer of the blank onto the web-type counter-element, wherein the blank is positioned in a delivery position by way of a gripping device;

FIG. 3: shows the apparatus according to FIG. 1 after advance of an application device and a securing element;

FIG. 4: shows the apparatus according to FIG. 1 after lamination of the counter-element onto the blank; and

FIG. 5: shows the apparatus according to FIG. 1 after transfer of the blank and release of the blank by the gripping device.

### DETAILED DESCRIPTION OF THE EXAMPLES

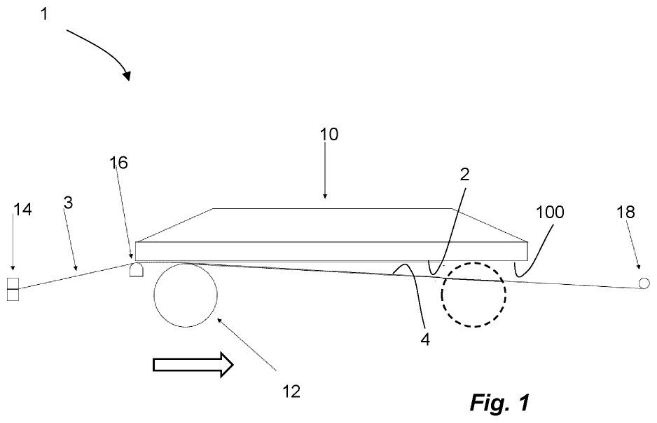

FIG. 1 is a schematic diagram of an apparatus 1 for transferring a blank 2 onto a web-type counter-element. The apparatus 1 comprises a gripping device 10 with a planar holding surface 100 and an application roller 12. The depicted apparatus 1 further comprises a clamping device 14, a securing element 16 and a deflection roller 18.

In the example shown, the web-type counter-element comprises a carrier web 3, on which a blank 4 has already been deposited.

The blank 2 to be applied or transferred onto the web-type counter-element is held and positioned by way of the gripping device 10. The blank 2 to be applied or transferred is also designated first blank 2. The blank 4 already present on the carrier web 3 in the example shown is also designated second blank 4. When being transferred to the counter-element, the first blank 2 needs to be applied to the second blank 4 in a defined position.

In some embodiments, the gripping device 10 comprises a vacuum gripping device, wherein the first blank 2 is held on the holding surface 100 of the gripping device 10 by reduced pressure. In the example shown, the holding surface 100 is pointing downward and, in a delivery position of the blank 2 shown in FIG. 1, the gripping device 10 is arranged above the web-type counter-element and parallel thereto.

Transfer of the first blank 2 onto the counter-element takes place when the web-type counter-element is at a standstill. To this end, the clamping device 14 is used to clamp the counter-element. The clamping device 14 is arranged upstream, in a direction of movement of the application device indicated by an arrow, of a portion of the counter-element onto which the first blank 2 is to be transferred. The deflection roller 18 is arranged downstream of this portion. The web-type counter-element is guided over a side of the securing element 16 facing the gripping device 10 and over a side of the deflection roller 18 remote from the gripping device 10.

The holding surface 100 of the gripping device 10 is larger than the first blank 2. To transfer the blank 2 onto the counter-element, the securing element 16 is advanced to the gripping device 10. In the example shown, the securing element 16 is advanced such that the web-type counter-element guided over the securing element 16 comes into contact with the holding surface 100 upstream of the first blank 2, when viewed in the direction of movement of the application roller 12. The deflection roller 18 prevents the web-type counter-element from bearing against the gripping device 10 when the securing element 16 is advanced.

The application roller 12 is likewise advanced to the gripping device 10 and moved from a starting position shown in FIG. 1 into an end position shown by dashed lines in FIG. 1, wherein, on movement of the application roller 12, the first blank 2 is transferred without bubbles onto the web-type counter-element, in the example shown onto the blank 4 already present on the carrier web 3.

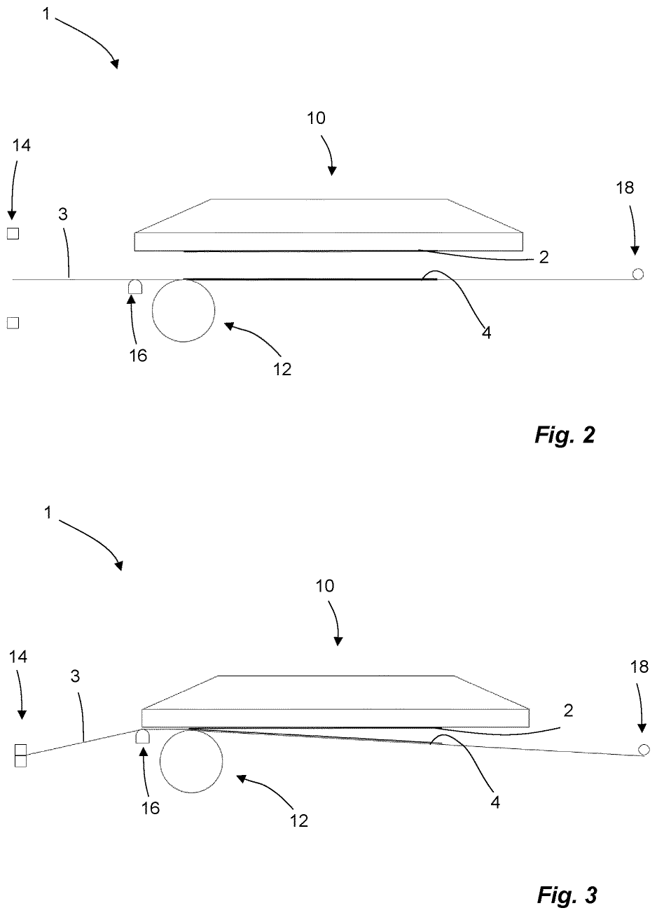

The following FIGS. 2 to 5 show individual steps of a method for transferring the first blank 2 onto the web-type counter-element.

FIG. 2 is a schematic diagram of a first step in the process of transferring the first blank 2 onto the web-type counter-element. The first blank 2 is held on the holding surface 100 of the gripping device 10 and is presented to the web-type counter-element at a defined distance above the web-type counter-element. This distance amounts to just a few millimeters, depending on the embodiment.

The web-type counter-element is then brought to a standstill in a starting position as shown schematically in FIG. 2 and secured by the clamping device 14 and the securing element 16 and the application roller 12 are advanced to the gripping device 10.

FIG. 3 is a schematic diagram of the apparatus 1 after the web-type counter-element has been brought to a standstill and secured by the clamping device 14 and after the securing element 16 and the application roller 12 have subsequently been advanced. The application roller 12 is preferably advanced to the gripping device 10 in such a way that it is arranged directly adjacently upstream of the blank 2 when viewed in the direction of movement of the application roller 12.

Next, the application roller 12 is moved along the gripping device 10 and rolled along the holding surface 100 of the gripping device 10. Thereby, the counter-element is laminated onto the first blank 2 positioned by way of the gripping device 10.

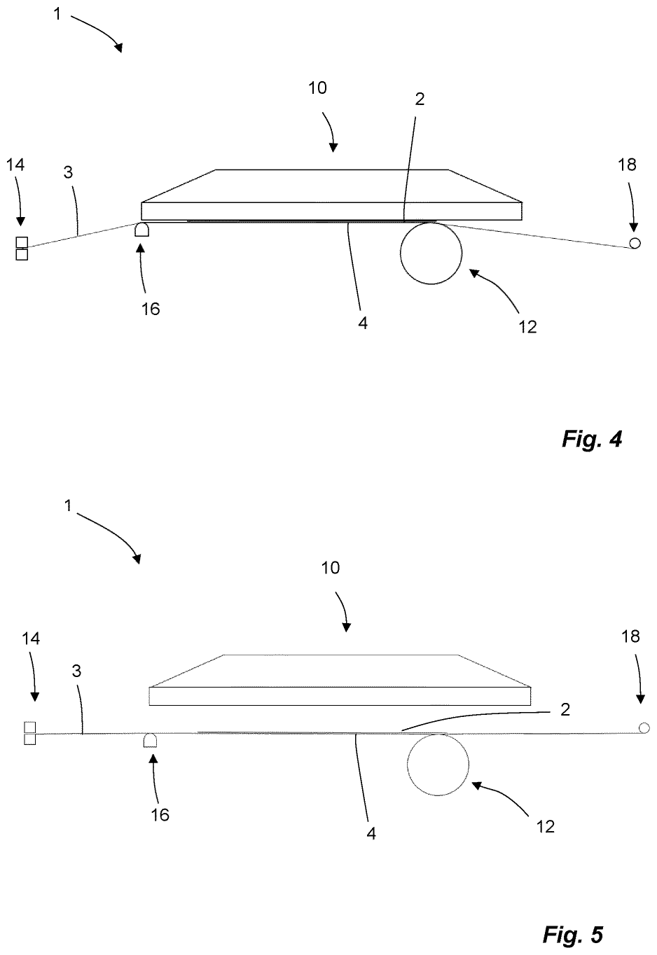

FIG. 4 is a schematic diagram of the apparatus 1 after the application roller 12 has rolled along the holding surface 100.

The securing element 16 and the application roller 12 are then moved away from the gripping device 10, downward in the example shown, such that the web-type counter-element is once again in the starting position. In an embodiment, the gripping device 10 is here moved downward with the counter-element, wherein the gripping device only releases the blank 2 once the counter-element is located in the starting position. The gripping device 10 is then moved away from the counter-element with the blank 2 transferred thereon. In another embodiment, the gripping device 10 releases the blank 2 in the condition shown in FIG. 4. The counter-element is then moved downward, until the counter-element is located in the starting position. For movement of the counter-element into the starting position, in an embodiment the securing element 16 is moved with a time delay relative to the application roller 12, such that a region of the blank 2 located on the right in the drawing plane becomes detached from the holding surface 100 of the gripping device 10 before a region of the blank located on the left in the drawing plane and the blank 2 is detached from the holding surface 100 at an angle. Any time offset and an angle resulting therefrom can be selected by a person skilled in the art to suit the use case.

FIG. 5 is a schematic diagram of the apparatus 1 after transfer of the blank 2 onto the counter-element.

The apparatus 1 serves, for example, to produce a membrane stack comprising two frame elements and a membrane, in particular a CCM, arranged between the two frame elements, wherein the frame elements and the membrane are in each case provided as blanks.

To produce the membrane stack, in an embodiment first of all a slightly tacky carrier web is supplied as the web-type counter-element. By way of the gripping device 10, a first frame element provided as a blank is held and positioned at a defined distance, for example a few millimeters, above the carrier web.

The carrier web is then secured by the clamping device 14 and the securing element 16 is advanced to the gripping device 10, such that the carrier web is secured by the securing element 16 against the flat or planar holding surface 100 outside the frame element which is to be applied and which is held by the gripping device 10.

At the same time as the securing element 16 or with a time delay relative thereto, the application roller 12 is brought into the starting position shown in FIG. 3 and thus presses the carrier web against the holding surface 100 shortly upstream of the first end of the blank which is to be applied and which is configured as a frame element.

The application roller 12 is then moved along the carrier web into the end position shown in FIG. 4. The carrier web is thus laminated onto the secured frame element.

In an embodiment, the gripping device is then moved downward together with the application roller 12 and the securing element 16 until the carrier web is in its starting position.

In an alternative embodiment, the gripping device 10 releases the frame element. The application roller 12 and, with a time delay relative thereto, the securing element 16 are then moved downward, such that the frame element becomes detached from the holding surface 100 at an angle and the carrier web with the frame element laminated thereon is moved into its starting position.

Once the frame element has been released, the gripping device 10 can be repositioned to pick up the next blank, for example to pick up the membrane, in particular the CCM, in order to build up the membrane stack. The membrane is then transferred in the same way to the carrier web. Transfer of the second frame element can then likewise take place in the same way.

Alternatively, three apparatuses 1 according to FIGS. 1 to 5 arranged one behind the other in the conveying direction are provided to build up a membrane stack, wherein the first frame element is deposited using a first apparatus, the membrane using a second apparatus and the second frame element using a third apparatus. The three apparatuses 1 operate in synchronized or offset manner.

1. A method for transferring a blank onto a web-type counter-element, wherein the blank is held on a planar holding surface of a gripping device and positioned by way of the gripping device relative to the web-type counter-element in a delivery position, the web-type counter-element is advanced to the holding surface by way of an application device, the application device is moved along the holding surface such that the web-type counter-element is laminated onto the blank by way of the application device moving along the holding surface and the gripping device releases the blank after lamination of the counter-element onto the blank.

2. The method according to claim 1, wherein the application device is an application roller which is rolled along the holding surface, or a doctor blade which is displaced along the holding surface.

3. The method according to claim 1, wherein the holding surface is larger than the blank at least in the direction of movement of the application device during lamination, and the counter-element is secured on the holding surface upstream of the blank by way of a securing element advanced to the holding surface.

4. The method according to claim 3, wherein the application device is advanced to the holding surface downstream of the securing element and upstream of the blank.

5. The method according to claim 1, wherein, before the application device is advanced, the web-type counter-element is brought to a standstill in a starting position for transfer of the blank, wherein in particular the counter-element is clamped by a clamping device upstream of the delivery position of the blank in the direction of movement of the application device during lamination.

6. The method according to claim 5, wherein the application device is removed from the holding surface after lamination of the counter-element onto the blank and the web-type counter-element is moved into the starting position, wherein in particular the gripping device is moved with the web-type counter-element and the blank remains on the holding surface during movement of the counter-element into the starting position or the gripping device releases the blank prior to movement of the counter-element toward the starting position.

7. The method according to claim 1, wherein, in the delivery position, the blank is positioned above the counter-element, wherein the application device is advanced to the holding surface from below.

8. An apparatus for transferring a blank onto a web-type counter-element comprising a gripping device with a planar holding surface and an application device, wherein the gripping device is configured such that the blank is holdable on the holding surface and positionable relative to the web-type counter-element in a delivery position by way of the gripping device, and wherein the application device is adjustably mounted and is advanceable to the holding surface and is movable along the holding surface for lamination of the counter-element onto the blank.

9. The apparatus according to claim 8, wherein the application device is an application roller which is configured such that the application roller can be rolled along the holding surface, or is a doctor blade which is configured such that the doctor blade is repositionable along the holding surface.

10. The apparatus according to claim 8, wherein the holding surface is larger than the blank at least in the direction of movement of the application device during lamination, and a securing element which can be advanced to the holding surface is provided and is configured to secure the counter-element on the holding surface upstream of the blank.

11. The apparatus according to claim 10, wherein the application device can be advanced to the holding surface downstream of the securing element and upstream of the blank.

12. The apparatus according to claim 8, wherein the web-type counter-element can be brought to a standstill in a starting position before the application device is advanced for transfer of the blank, wherein the apparatus in particular comprises a clamping device which is configured such that the counter-element is clampable by the clamping device upstream of the delivery position of the blank in the direction of movement of the application device during lamination.

13. The apparatus according to claim 12, wherein the gripping device is configured to release the blank directly after lamination of the counter-element onto the blank and/or to move the blank held on the holding surface with the counter-element into the starting position of the counter-element after lamination of the counter-element onto the blank.

14. The apparatus according to claim 8, wherein the gripping device is configured to position the blank in the delivery position above the counter-element, wherein the application device is configured such that the application device can be advanced to the holding surface from below.

15. The apparatus according to claim 8, wherein the gripping device is a vacuum-gripping device.
